(19) United States
(12) Patent Application Publication
(10) Pub. No.: US 2004/0093492 A1
(43) Pub. Date: May 13, 2004

(54) Virtual private network management with certificates

(76) Inventors: Olivier Daude, Nice (FR); Jacques Fieschi, Biot (FR); Claude Galand, Saint-Paul (FR); Olivier Hericourt, La Gaude (FR); Jean-Francois Le Pennec, Nice (FR)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/292,820

(22) Filed: Nov. 13, 2002

(51) Int. Cl. H04L 9/00

(52) U.S. Cl. 713/156; 713/201

(57) ABSTRACT

The present invention provides a secure definition of VPNs and configuration of devices that manage or handle these VPNs. The proposed invention provides a method to securely manage the definition of the configuration of the network devices in agreement with the above requirements for customers and providers, and provides, in addition, a method to perform the verification of implemented rules and parameters against stored and certified information. In the proposed method, digital certificates can be employed to define and certify configuration information.

### BACKGROUND OF THE INVENTION

1. Field of the Invention

The present invention relates to a networking environment where several VPNs are defined on networking devices. The present invention provides a global solution that is not linked directly with the type of device nor the VPN technology used but gives a very secure identity of each VPN configuration. More specifically, the present invention relates to securely defining and accessing portions of the configurations for devices located within different private networks.

2. Description of the Related Art

Virtual Private Networks (“VPNs”) exist which enable private communications among devices associated with a given VPN, even if some or all of the communications are transmitted over a public network. Most VPNs are broken down into categories that reside in different layers of the well-known Transmission Control Protocol/Internet Protocol (TCP/IP) protocol suite. In particular, the Network and Link Layers of the TCP/IP protocol suite (i.e., layers 3 and 2, respectively) are examples of layers commonly used to establish VPNs.

With respect to Network-Layer VPNs, there are several known methods for construction of such VPNs. As a first example, “route filtering” can be implemented to control route propagation such that only certain networks receive routes for other networks within their own community of interest (i.e., VPN).

Route filtering is based on the proposition that some network subset of an underlying IP network supporting the VPN (such as the Internet) actually forms the VPN. Routes associated with this network subset are filtered such that they are not announced to any other network(s) connected to the network subset forming the VPN. Conversely, no other non-VPN route is announced to the network subset.

Privacy of services on a network-layer, route filtering VPN is implemented by restricting any of the VPN hosts from responding to packets which contain source addresses from outside the VPN. Such restrictions are based on access control lists (“ACLs”), which are tables that tell a device which access rights each user has. That is, an ACL is a list of entries that grant or deny specific access rights to individuals or groups. The definitions of an ACL may be related to one VPN or may be related to the interconnection of several VPNs.

Conventional network-layer, route filtering VPNs, however, have various difficulties associated therewith. For example, such an arrangement can be misconfigured such that it erroneously accepts packets which it should not, and/or rejects packets that should be accepted. Additional shortcomings of this technique include administrative mistakes; a static nature of the design; and limitations on the security provided. In addition, the complexity for defining and maintaining all the rules is very high, so that the technique does not scale very well or very easily.

A second type of network-layer VPN is built using tunneling protocols. Generic Routing Encapsulation (GRE) is a network-layer tunneling protocol used to construct VPNs. (Layer 2 tunneling protocols, such as Layer 2 Tunneling Protocol (L2TP) and Point-to-Point Tunneling Protocol (PPTP) are also known and are discussed in more detail below).

GRE tunnels are configured between a source (ingress) router and a destination (egress) router, such that packets designated to be forwarded across the tunnel are further encapsulated with a new header (the GRE header), and placed into the tunnel with a destination address of the tunnel endpoint (the new next-hop). When the packet reaches the tunnel endpoint, the GRE header is stripped away, and the packet continues to be forwarded to the destination, as designated in the original IP packet header.

In the GRE tunneling protocol, routing for the VPN is isolated from routing of the customer. The VPNs can reuse the same private address space within multiple VPNs without any cross-impact, providing considerable independence of the VPN from the customer network.

Various difficulties exist with respect to implementing the GRE tunneling protocol. For example, GRE tunnels must be manually configured, which leads to excessive administrative overhead. Also, it is necessary to ensure that Customer Premises Equipment (CPE) routers are managed by the VPN service provider, because the configuration of the tunnel end-points is a critical component of the overall architecture of integrity of privacy. Therefore networking devices have information related to the VPN or VPNs themselves and also some information related to the service provider. For security reasons, generally only the service provider has access to such devices.

As a final example of a network-layer tunneling technique, IP Security (IPSec) has been developed. IPSec is a flexible framework for providing network-layer security. Earlier security protocols often protected only a portion of an end-to-end path, or forced the imposition of the same protection everywhere along the path. IPSec, in contrast, provides complete end-to-end network layer security, while giving the opportunity to tailor the security coverage on a segment-by-segment basis along any given path. IPSec protocols support data origin authentication, data integrity, data confidentiality, encryption key management, and management of security associations. Within the IPSec framework, a company can configure secure end-to-end solutions that can accommodate both locally attached users and remote access users, and can support communications both within the company and between different companies.

IPSec encrypted tunnel mode, nonetheless, still leaves the tunnel ingress and egress points vulnerable, because these points are logically part of the host network as well as being part of the unencrypted VPN network. Any corruption of the operation, or interception of traffic in the clear, at these points will compromise the privacy of the private network. In the tunnel mode, however, traffic that transits the encrypted links between participating routers is considered secure. The ingress and egress peering points are also networking devices shared by the customer and the service provider. Companies requiring a high level of security such as banks, police, administrations cannot accept that the service provider have access to these peering points as it might then have access to decrypted data.

In addition to network-layer VPNs, there also exist conventional link-layer VPNs. For example, link-layer protocols such as Frame-Relay or Asynchronous Transfer Mode (ATM) allow building VPNs as a set of Private Virtual Circuits (PVCs). The VPNs built are not generally fully-meshed (i.e., each of the VPN devices is not necessarily capable of communicating directly with all of the other VPN devices). Rather, they are only partially meshed, or use a Hub model. Although robust and simple, these protocols are not easily scalable, since any peer-to-peer connection is a dedicated PVC that needs to be configured manually. When several VPNs share a device, they generally get dedicated PVCs for the respective VPNs.

One method of addressing scaling issues in link-layer VPNs is to use VPN labels within a single routing environment, in the same way that packet labels are necessary to activate the correct per-VPN routing table in network layer VPNs. The use of local label switching effectively creates the architecture of the well-known Multi-protocol Label Switching (MPLS) VPN. The architectural concepts used by MPLS are generic enough to allow it to operate as a peer VPN model for switching technology for a variety of link-layer technologies, and in heterogeneous Layer 2 transmission and switching environments. MPLS requires protocol-based routing functionality in the intermediate devices, and operates by making the transport infrastructure visible to the routing.

MPLS VPNs have not one, but three key ingredients: (1) constrained distribution of routing information as a way to form VPNs and control inter-VPN connectivity; (2) the use of VPN-IDs, and specifically the concatenation of VPN-IDs with IP addresses to turn (potentially) non-unique addresses into unique ones; and (3) the use of label switching (MPLS) to provide forwarding along the routes constructed via (1) and (2).

Numerous approaches are possible to support VPNs within an MPLS environment. In the base MPLS architecture, the label applied to a packet on ingress to the MPLS environment effectively determines the selection of the egress router, as the sequence of label switches defines an edge-to-edge virtual path. The extension to the MPLS local label hop-by-hop architecture is the notion of a per-VPN global identifier, which is used effectively within an edge-to-edge context. This global identifier could be assigned on ingress, and is then used as an index into a per-VPN routing table to determine the initial switch label. On egress from the MPLS environment, the VPN identifier would be used again as an index into a per-VPN global identifier table to undertake next-hop selection.

In another approach to supporting VPNs within an MPLS environment, a Provider Edge (PE) router having a plurality of logical routers is configured such that each logical router corresponding to one VPN can be implemented with an entity of a routing protocol between PE routers whose processing is based on VPN Routing and Forwarding (VRF) tables. Based on the route information of a VRF table in a PE router, user traffic received from a CE (Customer Equipment) device or another PE router is forwarded to another CE device or PE router via an access or logical link respectively. For the dynamic routing service, a PE router distributes route information inside user sites, which is received from a CE device or another PE router, to another CE device or PE router using routing protocol between PE routers. A PE router implements one or more logical (i.e., “virtual”) routers. It is usually located at the edge of an SP (Service Provider) network.

In this model, dedicated VRFs and labels are given to VPNs. Common or global VRFs may be shared. In addition route import and export mechanisms enable visibility and routing from one VPN to another where needed. There is also a security issue in such mechanisms and Customers need to be sure that the rules defined are the one implemented.

Finally, tunneling techniques for link-layer VPNs also exist. For example, Virtual Private Dial Networks (VPDN) exist which use layer 2 tunneling techniques. There are three principal methods of implementing a VPDN: Layer 2 Tunneling Protocol (L2TP), Cisco Layer 2 Forwarding protocol (L2F) from which L2TP was derived, and Point-to-Point Tunneling Protocol (PPTP) tunnels. Such tunnels represent VPNs that can be static or dynamic tunnels with, in some cases, a preliminary authentication phase.

In short, various solutions have been put forward to achieve different levels of network privacy when building VPNs across a shared IP backbone. Many of these solutions require separate, per VPN forwarding capabilities, and make use of IP or MPLS-based tunnels across the backbone. Also, within a VPN domain, an instance of routing is used to distribute VPN reachability information among routers. Any routing protocol can be used, and no VPN-related modifications or extensions are needed to the routing protocol for achieving VPN reachability. Routing is therefore also an element that can be dedicated to a VPN or shared by several VPNs. Some Routing protocol instances may also be dedicated to the service provider.

Generally speaking, then, a VPN can take several forms. A VPN can be between two end systems, or it can be between two or more networks. A VPN can be built using tunnels or encryption (at essentially any layer of the protocol stack), or both, or alternatively constructed using MPLS or one of the “virtual router” methods. A VPN can consist of networks connected to a service provider's network by leased lines, Frame Relay, or ATM. As a final example, a VPN can consist of dialup subscribers connecting to centralized services or to other dialup subscribers.

Regardless of which of the above techniques (or other known techniques) is used to form a VPN, it should be understood that network security is a concern especially within devices shared by several VPNs.

In fact, network security is a concern in many contexts aside from VPNs, and, in general, increasing use of remote access over public networks and Internet access for inter-business communication are major driving forces behind the evolution of security technology.

In particular, public-key certificates (discussed in more detail below) and dynamic passwords are two technology areas that are growing rapidly to meet the security needs of today's networked environment. In the VPN arena, these security technologies are well-used in VPNs based on IPSec, but are not as advantageous when used in conjunction with other VPN technologies.

Regardless of the routing technique used, the routing mechanism is usually not used to implement security policy. That is, a routing mechanism is often considered too dynamic and unreliable to perform security functions. Routing functions and supporting structures are primarily designed to route packets efficiently and reliably, not securely. Therefore, filtering techniques that can be implemented in connection with operation of a firewall (and/or router) for security purposes exist, and examples of these (as referred to above) are packet filtering, application proxies, and dynamic filtering (stateful inspection).

Packet filtering on routers is used to allow, to the extent possible, only authorized network traffic. Packet filters specify packets to filter (discard) during the routing process. These filtering decisions are usually based on contents of the individual packet headers (e.g., source address, destination address, protocol, port). Some packet filter implementations offer filtering capabilities based on other information; these implementations are discussed in more detail in connection with stateful inspection described below.

Generally speaking, packet filtering routers offer the highest performance firewall mechanism. However, they are harder to configure because they are configured at a lower level, requiring a detailed understanding of protocols.

In addition rules may be defined at a VPN level, may be shared by some VPNs, or may be global rules.

Packet filtering is the process of deciding the disposition of each packet that can possibly pass through a router with packet filtering. For simplicity's sake, it can be assumed that there are only two dispositions: accept and reject. IP filtering provides the basic protection mechanism for a routing firewall host, allowing a determination of what traffic passes through based on the contents of the packet, thereby potentially limiting access to each of the networks controlled by the firewall router.

The criteria used in each filtering rule for determining the disposition can be arbitrarily complex. For a router with packet filtering, there may be multiple points in the routing process where the rules are applied; typically, for arriving packets, they are applied at the time a packet is received and, for departing packets, they are applied immediately before a packet is transmitted. There may be different rule sets at each point where filtering is applied. If the entire security policy can be implemented in packet filters, then other firewall mechanisms may not be required. If some elements of the filtering policy cannot be implemented with packet filters, then additional firewall mechanisms such as proxies may be necessary.

Although there are many techniques for implementing and securing individual VPNs, as discussed above, there is an additional need for VPNs which can cross-communicate without sacrificing service to their users, e.g., without reducing the security of transmissions between the two (or more) VPNs or within a particular one of the VPNs.

In considering the difficulties associated with interconnecting multiple VPNs, then, it should be considered that a VPN is generally built to solve some common problems. These problems include, for example, virtualization of services and segregation of communications to a closed community of interest. Thus, when two different networks using the same or different VPN technologies are interconnected, the VPN Networks interconnecting function must respect at least the following principles: security of network operations, maintenance of network integrity, interoperability of services and data protection. Issues that arise from these principles include: scalability, complexity, security, cost of deployment, and management.

Security, which can be implemented in various forms as already discussed, generally means preventing the hacking of packets, which may be snooped on, modified in transit, or subjected to traffic analysis by unauthorized parties. Additionally, security refers to avoiding misconfiguration errors that provide holes between two or more VPNs.

In inter-connecting different VPNs, whether a given VPN is behind a firewall device or not, some centralized VPN management tools enable secure connectivity between multiple customers and multiple services over a single connection, with flexible, centralized management and control. They simplify secure interconnection and management of networks with incompatible routing or address conflicts. They are generally limited to the type of equipment used and vendor. Such VPNs are centralized and have no secure feedback.

Such centralized configuration VPN systems allow the setting of network policies involving hardware devices, as well as user registration functions to set network policies and privileges. These conventional systems are based on what is known as an Access Control List (“ACL”). ACL-based management systems essentially manage ACLs that are residing in routers that control traffic flow and provide some level of security of access. They can also perform the monitoring of user activity to determine when users are connected and where they're mapped, from a policy standpoint, to virtual LANs in the network. ACLs allow administrators to define security and traffic control policies for management across devices, according to the controlling company, and are also commonly used for securing Internet access. ACLs can be centrally managed through a template library. Access list configurations can be managed for groups of users and for devices and network services used in VPNs. ACLs are downloaded to each device in the network.

The centralized ACL configuration is static, and does not lend itself to automation. If another configuration tool is used, or a manual modification is performed by a user that has been granted access (or by a user who has mistakenly or illicitly gained access), there is no direct verification of the user and/or system done to check for errors or other problems.

An ACL may also take the form of a filtering statement in firewalls, while using the same mechanism described above. Sometimes several similar rules are duplicated in cascaded equipments because there is a lack in confidence in what has been defined in other devices. ACL use has a high impact on computing resources and performance for all devices, therefore any simplification would improve network performance noticeably.

In short, no conventional approach currently exists which permits definition and configuration of VPNs in a secure, efficient, scaleable, reliable and decentralized manner.

### SUMMARY OF THE INVENTION

The present invention provides a secure definition of VPNs and configuration of devices that manage or handle these VPNs. Part of the definition comes from customer inputs, the customer being the owner of a VPN. The customer should be sure that its VPN parameters become unchanged in the network. The customer should also be able to securely change these parameters and get confirmation of the change. The service provider manages the equipment or devices, and also has some specific definitions for the equipment, and having the need to securely configure its network. In addition some definitions may be common to several customers, several VPNs, or common to some customers and the provider. The proposed invention provides a method to securely manage the definition of the configuration of the network devices in agreement with the above requirements for customers and providers, and provides, in addition, a method to perform the verification of implemented rules and parameters against stored and certified information.

### BRIEF DESCRIPTION OF THE DRAWINGS

The present invention is described with reference to the accompanying drawings to which like reference numbers indicate identical or functionally similar elements.

FIG. 1 is a schematic view of networking environment illustrating one embodiment of the present invention.

FIG. 2 shows examples of flows between a customer workstation, a provider configuration system and management servers for building a digital certificate associated with a VPN device configuration in accordance with an embodiment of the present invention.

FIG. 3 shows examples of flows for configuration verification, based on network device pooling between a customer workstation, management servers and network devices.

FIG. 4 shows an alternate method for configuration verification done directly in a customer workstation.

FIG. 5 shows an alternate method for configuration verification done in a management system.

FIG. 6 shows an example of a VPN configuration digital certificate structure according to an embodiment of the present invention.

### DETAILED DESCRIPTION

As explained above, in today's networks, devices such as routers, servers, firewalls, gateways may be shared among several VPNs. A VPN may be a customer Private Virtual Network managed by a service provider. A customer may have several VPNs defined for his needs: for example one per internal division or subsidiary. Therefore devices that are handed or shared by several VPNs have complex configuration files: some relate to a specific VPN; some relate to shared parameters for a group of VPNs; some concern configuration items common to all VPNs (global); and some, not related to VPNs, but to the device itself and to the administration of this device.

The idea is to build a structure of a digital certificate that may be used by the customer to which the VPN belongs and by the service provider which manages the device. Customers want to have some visibility of what is defined for them on each device on which they have been defined. At the same time, service providers do not want to give a full view of device configuration to customers. VPN Digital Certificates allow verifying the integrity of the VPN configuration. A Digital Certificate may be used as a method for configuring devices on a VPN per VPN basis.

This solution is based on digital certificates and therefore may be easily deployed and insure a high security level that can be used for configuration including filtering and routing rules in the gateway and security management, thus integrating the different network management tools.

An overview of digital certificates and filtering technologies is therefore necessary to better understand the interconnection of these functions.

A Digital Certificate is a structure that contains a public value (i.e., a public key) that is bound to an n identity. Within a X.509 Certificate the public key is bound to a “user's name”. A third party (the Certificate Authority) has attested that the public key does belong to the user. When a client receives a certificate from another user the “strength” of the binding between the public key and identity can vary.

A Certificate Authority (CA) processes digital certificates for implementing secure network connections such as VPNs. A Certificate is a structure that contains a public value (i.e., a public key) that is bound to an identity. Within a specific type of Certificate, such as the X.509 Certificate, the public key may be bound to a “user's name”. The CA attests that the public key belongs to the user, so that when a client receives a certificate from another user the “strength” of the binding between the public key and identity can vary depending on the reliability of the particular CA being used.

An X.509 Digital Certificate in particular has a very formal structure in some respects, yet maintains a degree of flexibility in other respects. Those elements that are always contained in a certificate are as follows:

Subject This is the “user's name” referred to above, although the subject field can in fact be any identity value. A number of name spaces are supported. The default is X.500 Distinguished Names (e.g., c=GB, o=Integrity, cn=hughes). Alternative name spaces supported include RFC822 e-mail addresses (e.g., john@entegrity.com).

Issuer This is the name of the Third Party that issued/generated the certificate, that is, the Certificate Authority 200. The same name spaces are used as defined for the Subject field.

Public Value This is the public key component of a public/private key pair. An associated field defines the public key algorithm being used, for instance whether it is an RSA, Diffie-Hellman or DSA public key.

Validity Two fields are used to define when the certificate is valid from and valid to. Combined together these provide the validity period.

Serial Number This is a field that provides a unique certificate serial number for the issuer of the certificate.

Signature This is how the Subject identity and the Public Value are bound together. The signature is a digital signature generated by the CA 200 over the whole certificate, using the CA's private key. By having signed the certificate the CA “certifies” that the Subject is the “owner” of the public key and therefore has the corresponding private key. X.509 Version 3 (“V3”) is a version of X.509 certificates that adds an extensibility mechanism to the original X.509 certificate format. Certificate extensions can be defined in standards fields or by user communities. Some examples of certificate extensions are: alternative name forms, key identifiers, key usage, subject attributes, certificate policies and constraints.

Additional specific extensions may also be built. As will be discussed in more detail below, one embodiment of the present invention contemplates the integration of extensions for VPN identification and related rules, whereby management of devices can take advantage of the security provided by digital certificates.

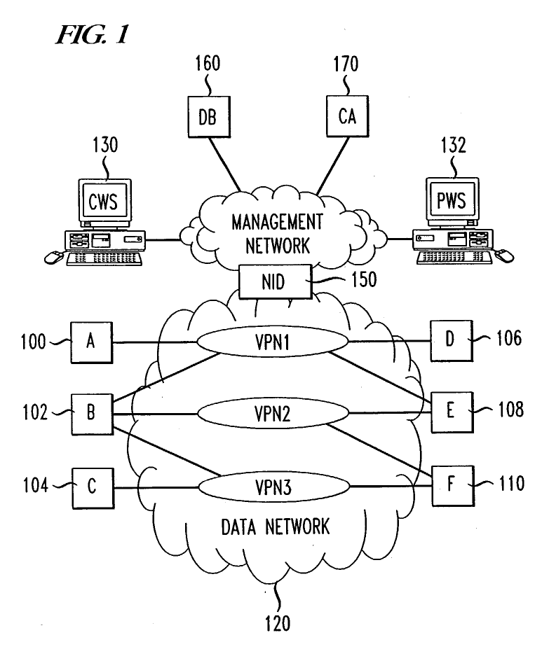

FIG. 1 is a simplified representation of a multi-VPN network with associated management tools. Two networks are shown:

A network management network 140, on which the customer workstation (CWS) 130 and the provider workstation (PWS) 132 both have access. Several management servers are implemented on this network, such as a database system (DB) 160 and a Certificate Authority (CA) 170.

A DATA NETWORK 120, which may be accessed by devices located on Network Management 140 via a gateway called Network Interworking Device (NID) 150. This device acts as a filtering and proxy device for access to devices' configuration data.

Several devices and several VPNs are shown on DATA NETWORK 120. Three VPNs labeled VPN1, VPN2 and VPN3 exist on this network. Devices may belong to one or more VPNs. As an example, device A 100 and device D 106 belong only to VPN1. Device E 108 belongs to both VPN1 and VPN2. Device B 102 belongs to VPN1, VPN2 and VPN3. Device C 104 belongs only to VPN3 while device F 110 belongs to VPN2 and VPN3. This example shows that a device may belong to one or more VPNs and that devices may not be grouped easily as part of defined VPNs so as to simplify the structure of device VPN certificates.

The configuration file with respect to each device needs to be structured in a way easy to build and easy to use. Therefore, according to this example a configuration file of device A will contain: a provider set of commands and parameters; a VPN1 set of commands and parameters; and possibly a global set of commands and parameters. The global set of commands in case of a single VPN configured in a device is not really necessary but is required when more VPNs are defined to show the common set of commands and parameters between VPNs. An authorized administrator for VPN1 on CWS workstation may have access to the VPN1 part of the configuration of device A as well as the global part, if any, but will not have access to the provider part of the configuration. Only a provider administrator on workstation PWS will have access to all parts of the configuration.

In case of a device belonging to more than one VPN, such as devices B, C, E or F, the partitioning of the configuration data is a little bit more complex. If we take the example of device E 108, four independent configuration parts may be found: the VPN1 dedicated part, the VPN2 dedicated part, the provider part and the global part.

A more complex case is shown with device B on which in addition to the VPN1 dedicated part, the VPN2 dedicated part, the VPN3 configuration part, the provider part and the global part, we may have configuration data shared by some VPNs such as a shared part VPN1-VPN2, a shared part VPN1-VPN3 and a shared part VPN3-VPN2. The number of possible parts for shared configuration information increases with the number of VPNs to which a device belongs. The configuration data associated with shared VPNs concerns, for example, the routing and filtering implemented to access one VPN from another: it includes commands such as route import and export and some access lists.

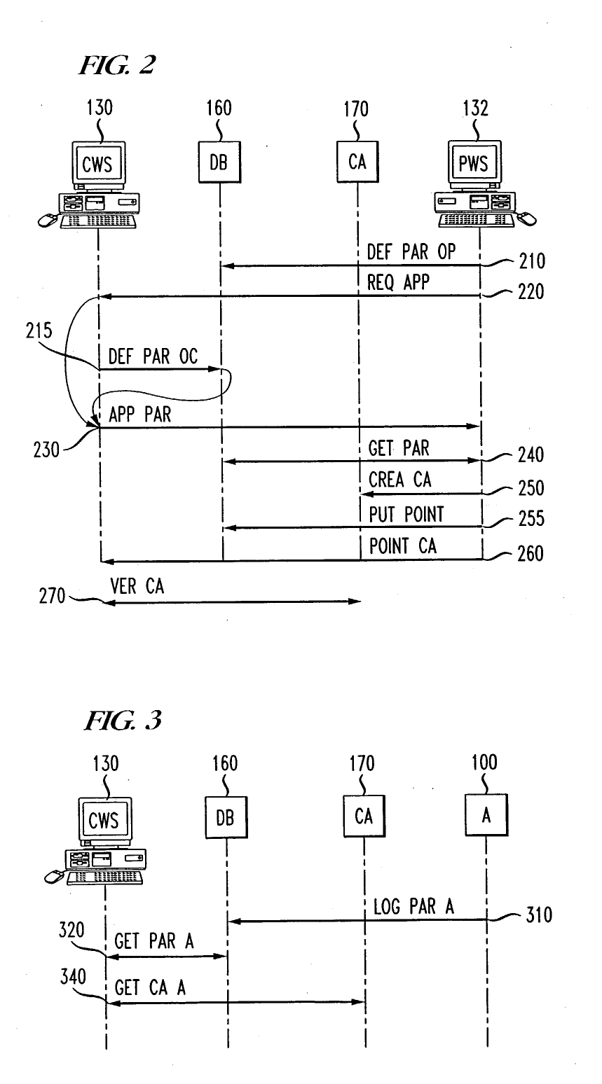

FIG. 2 will be used to describe a mechanism to build a certificate according to a configuration stored in database DB 160, that is, the master database for building configuration files located on network devices. Normally a device configuration file reflects what is stored in the database (DB) and the certificate authenticates this configuration so that at any time the real configuration file within the device itself can be compared to this digital certificate. When creating the configuration, database DB is used to input parameters which are split into configuration parts according to the definition explained in connection with FIG. 1, e.g., VPN part, shared VPN part, global part and provider part. Once created, each configuration part is stored in a certificate in CA 170. DB 160 maintains pointers to each certificate to have the capability to rebuild or compare a full device configuration file. Then customers may access, create and get certificates corresponding to VPNs.

Two mechanisms for defining parameters and certificates are shown in FIG. 2. The first mechanism relates to when the parameters of the configuration including VPN are defined by the provider on PWS and the second mechanism relates to when the customer enters its own parameters directly on DB 160. In both cases, the customer approves the configuration before creating the corresponding digital certificate.

The first mechanism starts with two steps: The first step 210 is the definition and storage by a user on provider workstation PWS 132 of the parameters corresponding to a device. This is represented as command DEF PAR OP (DEFine PARameters On PWS). This step is followed by a request for approval REQ APP 220 sent to an administrator on a customer workstation CWS 130 to have this set of parameters approved before first applying them and, in parallel to the application, creating the corresponding certificate.

The second mechanism is a direct definition of parameters on database DB 160 by the customer from workstation CWS 130. It corresponds to step 215 and message DEF PAR OC (DEFine PARameters On CWS). In both cases, after step 220 or 215, an approval of parameters APP PAR is sent by CWS to PWS in step 230. Then PWS, in step 240, gets the approved configuration data thanks to a GET PAR command and formats them in order to create a Certificate CRF CA, step 250, with the help of Certificate Authority CA 170. The Certificate may then be stored on the CA itself or on DB 160. In the former, the fields used to search for configuration information in the database DB are replaced by pointers to the Certificate in CA by PUT POINT command in step 255. The same pointer is given by POINT CA, on step 260, to CWS for further use or for local storage if needed. Then, at any time, a user on CWS, can verify that the certificate on CA is still valid using VER CA command on step 270. PWS can of course perform the same action.

FIG. 3 illustrates a method of verifying that the parameters really used on the device correspond to what has been certified. Regularly, network management tasks poll the devices. It includes protocols such as SNMP GET commands or TELNET logging to get or modify the configuration file. Step 310, LOG PAR A corresponds to such polling action to get the configuration parameters from device A 100 and log them into database DB 160. Regularly CWS station 130 can retrieve this log of parameters on DB 160 by GET PAR A command on step 320 as well as getting the corresponding certificate on CA 170 using GET CA A command on step 340. Then CWS is able to compare the two sets of data and verify that device A is still using the right set of parameters.

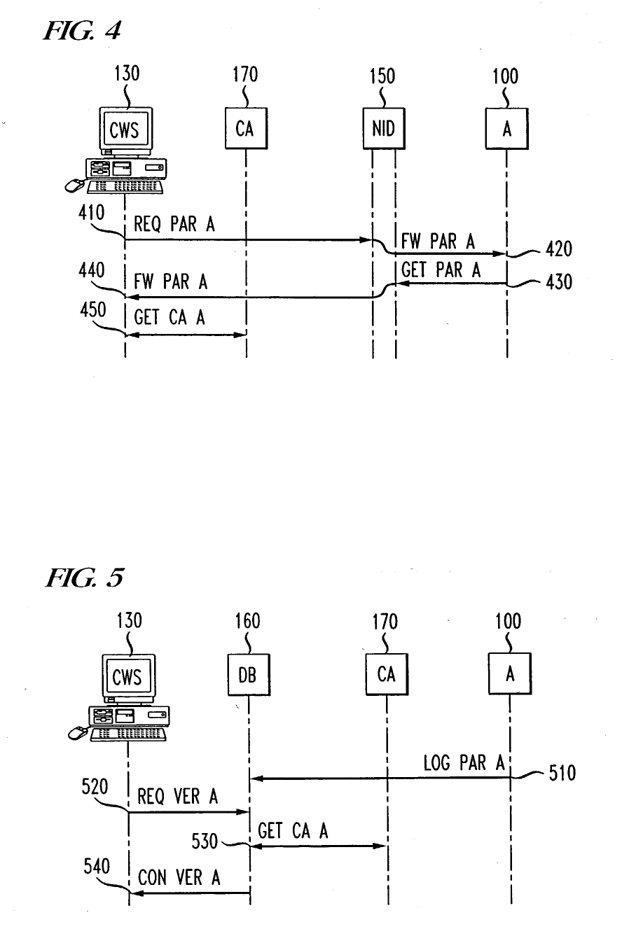

FIG. 4 is an alternate implementation for checking in response to a CWS request whether the configuration of device A is still valid without waiting for regular polling. In this mode, DB 160 is no longer involved to store the log of the polling, as polling is no longer used. Instead, the Network Interface Device NID 150 acts as a proxy in both directions in this implementation. The process starts on step 410 by a Request for Parameters of A 100 device REQ PAR A that is intercepted by the NID proxy 150. NID 150 may verify the rights of CWS against device A 100 and the request fields. If agreed, NID proxy forwards the request FW PAR A to device A 100 in step 420 using a network management command, using authentication if required. Therefore the authentication ID/password (TELNET for example) is only known by NID and never by CWS.

NID 150 gets back the corresponding parameters GET PAR A, step 430. According to the CWS request, at this stage, NID may perform some filtering of the data received from device A as the network management commands may not be selective enough. This avoids sending more data to CWS than CWS needs to know. The extracted data corresponding to what CWS has requested is then forwarded to CWS in step 440 by the action FW PAR A. The remaining task, similar to the fourth step of FIG. 3 is for CWS to get the corresponding Certificate to be able to perform the comparison: this corresponds to step 450: command GET CA A.

FIG. 5 is another alternative to the method described with respect to FIG. 3 in which the CWS doesn't get any configuration data and the comparison process remains in database DB 160. It can be also a mechanism used by PWS as the provider trusts its server environment.

As described in FIG. 3, regularly network management tasks poll the devices. In step 510, LOG PAR A corresponds to such polling action to get the configuration parameters from device A 100 and logs them into database DB 160.

CWS station 130 can request a verification of parameters of device A by REQ VER A to DB 160 in step 520. DB 160 then gets the corresponding VPN digital certificate from CA 170 using GET CA A command on step 530. Then DB 160 is able to compare the two sets of data and verify that device A is still using the right set of parameters. In answer to CWS, DB 160 confirms that parameters defined in the VPN digital certificate are still active on the device A by answer CON VER A “Confirm Verification of A” on step 540.

This method may also be used when CWS is on an insecure network, for example, using remote access. Both methods may coexist depending on CWS type or users.

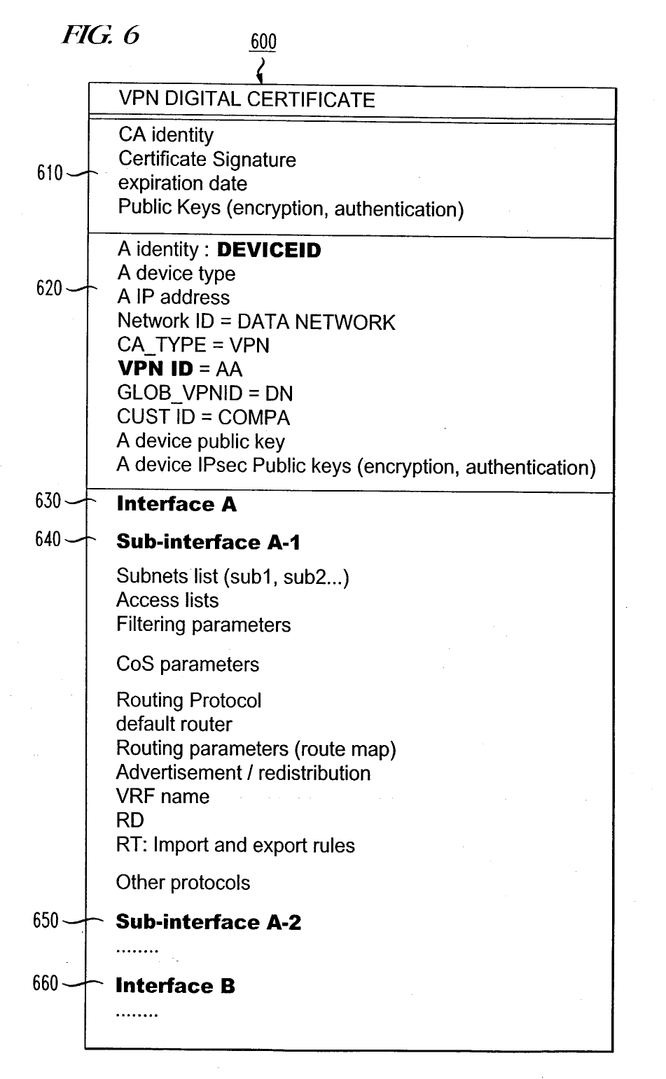

As shown in FIG. 6, which represents the structure of a device VPN digital certificate, a portion 610 of a digital certificate 600 may contain the certification authority (CA) identity and signature as well as the certificate expiration date and CA public keys (for encryption and authentication), while a portion 620 contains various information for device 100 having address A, including its identity that may be called the DEVICEID; IP address to reach it for verification via the network management network which can be different from its operational address on data network; the identification of the network on which this device is connected such as DATA NETWORK 120; the certificate type that can be single VPN, VPN list, global or provider; the VPN ID as even if it is a list, global or provider certificate it will be using an ID called VPN ID which is called in our example AA; the global GLOB_VPN ID, called DN, which is used in fact to group several VPNIDs sharing devices or networks; and finally a customer id CUST ID (or name but preferably id for security reason) whose value is COMPA in this example. This portion contains also the device A public key, IPSec authentication public key, and IPSec encryption public key. A further portion 640, used when the device is a router or gateway, contains the list of subnets that have to be managed through the VPN as well as the routing protocol and associated routing parameters related to this connection: route distribution, static routes definitions, default router, etc.

Device VPN digital certificate contents starts with portion 630 on which each interface and then each sub interface, such as 640 and 650 for interface A, are described with regards to the parameters related to the VPN for which the certificate is built.

Within a VPN a set of configuration parameters is defined for each device. A device VPN digital certificate may contain for each VPN a list of entities related to this VPN as shown in block 630 starting with Interface A.

Entities may be interfaces (physical), sub-interfaces (logical), addresses (list or range), routing parameters, security parameters (IPSec definitions, authentication, Keys, . . . ). Sub interfaces are optional and parameters may be applied directly to interfaces depending on design.

The configuration entities that are VPN dependent on an interface or sub-interface are: VPN names used on the network and the routing instances to each VPN. As an example it may be related to PE to CE parameters for Routing Sessions such as BGP, RIP or static routing for each VPN.

In a MPLS environment some specific parameters exist especially in a PE, it includes a VRF name to each routing instance, routing and forwarding tables (route distinguisher), list of import and/or export route target communities for the specified VRF (route target), specified route map with the VRF (import map), VRF associated to a set of interfaces or sub-interfaces, routing parameters associated to a CE to PE link, routing session parameters if dynamic routing is used between PE and CE, commands for advertisement or redistribution of the IPv4 address family (included in the VRF).

Other protocols used within this VPN may also be included at this level. Quality of service parameters including classes of services definitions and filtering rules are also parameters that may be dedicated per VPN.

Some of the parameters or commands may be defined as active so as to play a role in the configuration. Some may be shown but are defined as shadows as they are related to the VPN but are not active unless they are activated through another certificate. The idea is to have a command active only in one certificate. This is for example the case for import and export routing rules which are against two different VPNs: Both VPNs should know that this command is activated but only one VPN is responsible for activating it in its own VRF.

Once a digital certificate is issued it has to be stored in the CA but users should have an easy way to access certificates. The way Certificates are registered, managed, and accessed is explained hereunder:

A VPN digital certificate may be structured as: a static creation of VPNwithinDEVICE certificate, or a dynamic one as explained hereunder. VPN digital certificates are used by customers for managing each VPN separately. There is a need to correlate VPN digital certificates for several devices within a VPN. A first solution is to provide a master VPN certificate per VPN which includes the list of all devices on which VPN settings have been defined and a master MASTER_VPN certificate which lists all the VPNs available in the network or part of the network associated to the global VPN identified by the GLOB_VPNID. In that case the MASTER VPN is a GLOB_VPN certificate. The objective is to build a hierarchy allowing to retrieve all sub-certificates for dedicated VPNs. A master ALL_DEVICES certificate is also useful to list all devices on which VPNs have been defined. Master certificates are root certificates that are given first to requesters (customers or provider management people). They allow recovering the full structure of certificates using another tree based on physical devices.

The static creation means that for each device a set of certificates are built for each VPN (VPNperDEVICE) certificate including, if needed, dedicated VPN settings, shared settings and global settings. In that case the master VPN certificate includes pointers to these dedicated VPNperDEVICE certificates.

The dynamic creation means that a DEVICE VPN certificate is built including all VPNs parameters and rules. Upon a customer request a dynamic digital certificate is built extracting the required fields from the global DEVICE VPN certificate. In that case the master VPN certificate includes pointers to these DEVICE certificates. Dynamic digital certificates are not stored within the CA but contain reference to the certificate from which they are extracted which allows a full authentication.

The static creation is easier to use but requires that more VPN digital certificates be built and stored. The present invention provides a method by which VPN digital certificates can be used to build and manage virtual private networks. While the description of the invention has referred to certain specific parameters or configuration attributes, it should be recognized that these are merely examples and this approach of using VPN digital certificates can be extended to other aspects of managing Virtual Private Networks.

Static or Dynamic difference concerns only the way VPN digital certificates are managed, stored within the CA, and provided to requesters. It has no impact on the content of certificates. A device VPN certificates just contains the equivalent data from several VPN digital certificates related to a defined device. Therefore in the text and claims, the phrase VPN digital certificates is meant to be so broad as to encompass the approach of independent VPN certificate per VPN and/or the more global DEVICE VPN certificate.

What is claimed is:

1. A method for aggregating parameter information for a device to be associated with vertical private network (VPN), the method comprising:
receiving configuration parameters determined by a service provider supporting the VPN;
receiving configuration parameters determined by a customer associated with the VPN;
generating a VPN digital certificate including received configuration parameters; and
storing the generated digital certificate.

2. The method of claim 1 further comprising:
receiving an indication of customer approval for received configuration parameters determined by a service provider.

3. The method of claim 2 wherein said receiving an indication of customer approval occurs prior to the generating of the VPN digital certificate.

4. The method of claim 1 further comprising:
presenting the VPN digital certificate to a Certification Authority; and
storing a pointer to the certificate.

5. The method of claim 1 wherein the VPN digital certificate includes a plurality of fields including:
a public key associated with the device; and
a set of configuration parameters associated with the device, including filtering parameters.

6. A method for establishing configuration parameters for a device for use in a vertical private network (VPN) associated with a customer, the VPN being administrated by a service provider, the method comprising:
generating configuration file information defined by the customer;
generating configuration file information defined by the service provider; and
applying the generated configuration file information to the device.

7. The method of claim 5 wherein the configuration file information defined by the customer includes a set of commands and parameters corresponding to the VPN and the configuration file information defined by the provider includes a set of commands and parameters corresponding to multiple VPNs.

8. The method of claim 5 further comprising:
generating configuration file information defined by a second customer in connection with a second VPN.

9. The method of claim 5 further comprising:
generating a digital certificate including the generated configuration file information.

10. A method for verifying configuration parameters of a device in a virtual private network (VPN), the method comprising:
retrieving a log of configuration parameters from the device;
retrieving a device VPN digital certificate having a definition of device configuration parameters; and
comparing the retrieved log to the retrieved certificate.

11. The method of claim 10 wherein said comparing is performed by a customer work station.

12. The method of claim 11 further comprising:
filtering data from the retrieved log to select a subset of file data; and
forwarding the subset of the data from the retrieved log to the customer work station.

13. The method of claim 10 wherein said comparing is performed by a service provider database; and further comprising notifying a customer of the result of the comparing.
